(19) United States
(12) Patent Application Publication
(10) Pub. No.: US 2017/0281324 A1
(43) Pub. Date: Oct. 5, 2017

(54) DENTAL TREATMENT TRAY DEVICE

(71) Applicant: Joshua James Cheetham, Chicago, IL (US)

(72) Inventor: Joshua James Cheetham, Chicago, IL (US)

(73) Assignee: SDI North America Inc., Chicago, IL (US)

(21) Appl. No.: 15/473,546

(22) Filed: Mar. 29, 2017

(30) Foreign Application Priority Data
Mar. 30, 2016 (AU) 2016901164

(51) Int. Cl. A61C 19/06

(52) U.S. Cl. CPC A61C 19/066; A61C 2202/00; A61C 2201/002

(57) ABSTRACT

A dental treatment tray device comprising a horseshoe shaped insert with peripheral front and rear walls 16 defining a trough shaped device 12 in cross section with an Intermediate base layer. The front and rear walls 14 and 15 and the base layer are lined by means of gauze impregnated with dental treatment material 18.

### FIELD OF THE INVENTION

The present invention relates to a dental treatment tray device.

### BACKGROUND

It is known to provide dental treatment devices which are generally of horseshoe shape and are formed with a trough.

The devices generally comprise a trough front wall and a trough rear wall with an intervening base region. The devices are configured to engage with the teeth of a user. The trough contains a treatment material such as a dental whitening gel or a desensitising gel or a fluoride gel.

It has been found that known dental treatment devices have a problem in that it is difficult to control the placement of the treatment material in use.

### SUMMARY OF THE INVENTION

The present invention seeks to overcome problems encountered with previously known dental treatment devices.

In accordance with one aspect of the present invention there is provided a dental treatment tray device comprising a horseshoe shaped insert with a peripheral front wall and a peripheral rear wall, the front and rear walls defining a trough shaped device in cross-section with an intermediate base layer, wherein the front and rear walls and the base layer are lined by means of a layer of gauze impregnated with dental treatment material.

The trough of the dental treatment tray device of the present invention may be enclosed in a peelable material protective layer such as a plastics layer. The trough is preferably formed of a soft flexible plastics material which can conform to the shape of the user's teeth. The enclosing protective layer may be formed of a more rigid material to facilitate protection and use of the device with volatile compositions. The enclosing layer is arranged to be removed and discarded when the device of the present invention is in operation.

### BRIEF DESCRIPTION OF THE DRAWINGS

The present invention will now be described, by way of example, with reference to the accompanying drawings, in which:—

FIG. 1 is a perspective exploded view of a dental treatment tray device in according to the present invention;

FIG. 2 shows the device of the present invention progressing through stages of use;

FIG. 3 is a perspective view of a device of the present invention applied to a set of teeth;

FIG. 4 is a plan view of the arrangement shown in FIG. 3;

FIG. 5 is a schematic view of part of the device of FIG. 1 showing the disposition of a gauze material in the device; and

FIG. 6 is a view of a sample of gauze material which may be used in the present invention.

### DETAILED DESCRIPTION OF THE DRAWINGS

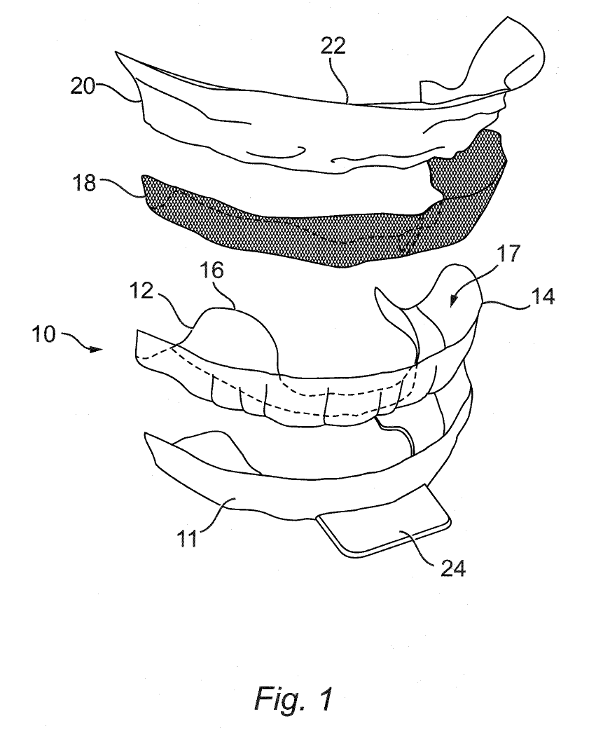

In FIG. 1 of the accompanying drawings there is shown a dental treatment tray device 10 which has an overall horseshoe shape when viewed in plan. The device 10 comprises a curved trough 12 which extends throughout the length of the device 10. The trough 12 is defined by an upstanding front wall 14 and an upstanding rear wall 16, together with an intermediate base 17.

The trough 12 is lined with a layer of gauze material 18 which is fixed to the trough 12 by processes such as ultra-sonic welding, gluing or other means. The layer 18 extends across the base 17 of the trough 12 and extends up the wall 14 and the wall 16 to points adjacent upper ends thereof.

The gauze material 18 is impregnated with a dental treatment gel material. The gel can take many forms but may be for whitening of teeth, a fluoride gel, a soothing gel or a tooth remineralising agent by way of example. The gauze material 18 may be impregnated with a sufficient quantity of dental material to provide appropriate doses to a user's teeth. The tray device 10 is preferably formed of a soft clear flexible plastic material.

It has been found that a separate light coloured, preferably white transfer device 11 has the advantage of providing guidance to a dental practitioner to apply the tray device 10. As shown the transfer device 11 is provided with a manual tab 24 to assist in providing guidance to the dental practitioner in use.

The application of the gauze material 18 has the advantage of applying treatment material in a controlled manner and reduces a possibility of treatment material being dislodged from the tray 10 into the mouth of the patient. Also, the amount of treatment material required is reduced compared to prior art devices.

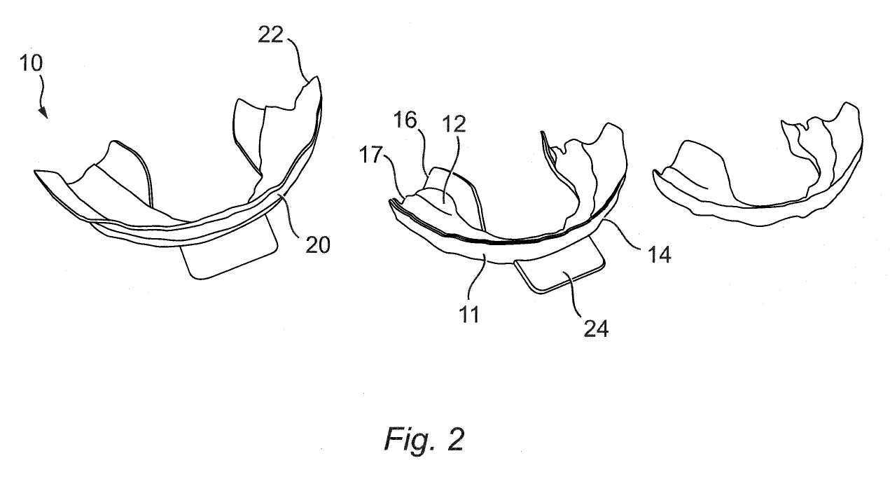

Preferably the tray device 10 is supplied with a protective layer 20 as shown in FIGS. 1 and 2. As shown in FIGS. 1 and 2, the device 10 is enclosed in a protective layer 20 in the form of an outer plastics material layer 22.

The device 10 with a protective layer 20 is presented to a patient. The protective layer 20 is then removed as shown in FIG. 2. Then while the device 10 is held by the light-coloured transfer device 11 the user inserts the device 10 into the mouth by means of this tab 24.

The transfer device 11 is then manually removed, leaving the device 10 on the patient's teeth.

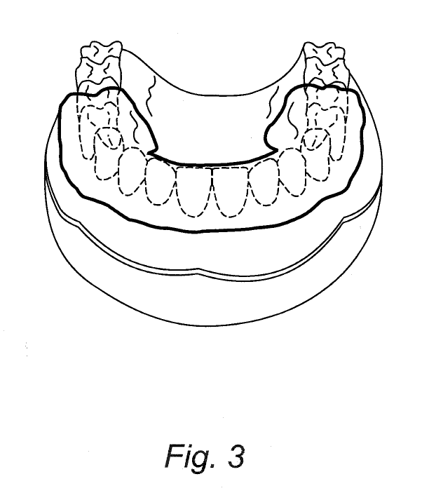

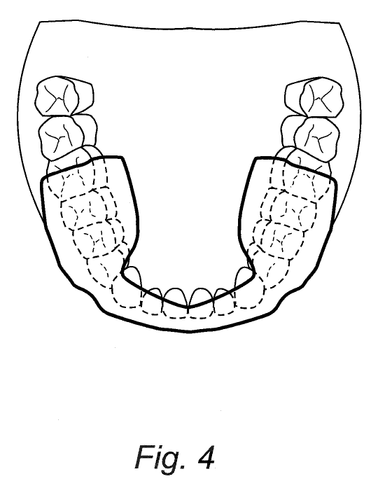

The application of the device 10 to teeth with the protective layer 20 and the transfer device 11 removed is shown in FIGS. 3 and 4.

The gauze layer may be a woven, knitted, braided or non-woven material or be a hybrid fabric made of polymer material such as polyethylene, polyethylene terephthalate, and similar materials.

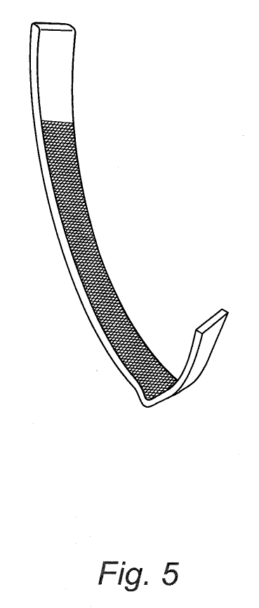

The gauze layer is permanently bonded to the trough 12 by adhesive means or by welding or by other means, for example, as shown in FIG. 5.

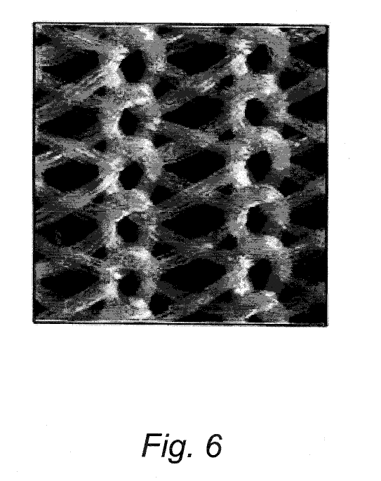

A typical knitted material useful for the gauze used in the present invention is shown in FIG. 6.

In operation, the tray device 10 is applied to a patient's mouth until the treatment is completed. The tray device 10 can be simply removed from the patient's mouth after use and discarded.

Modifications and variations such as would be apparent to a skilled addressee are deemed within the scope of the present invention.

1. A dental treatment tray device comprising a horseshoe shaped insert with a peripheral front wall and a peripheral rear wall, the front and rear walls defining a trough shaped device in cross-section with an intermediate base layer, wherein the front and rear walls and the base layer are lined by means of a layer of gauze impregnated with dental treatment gel material.

2. A dental treatment tray device according to claim 1, wherein the gel material is for whitening teeth, a fluoride gel, a soothing gel or a tooth remineralising agent.

3. A dental treatment tray device according to claim 1, wherein the trough shaped device is formed of a soft flexible plastics material which is able to conform to the shape of the user's teeth.

4. A dental treatment tray device according to claim 1, which is enclosed in a peelable material protective layer which is arranged to be removed when the device is in use.

5. A dental treatment tray device according to claim 4, wherein the protective layer is formed of a material which is relatively rigid to facilitate protection and use of the device with volatile compositions.

6. A dental treatment tray device according to claim 1, wherein, a transfer device is provided to assist in providing guidance to a dental practitioner in use.

7. A dental treatment tray device according to claim to 6, wherein the transfer device is provided with a manual tab to assist in insertion of the device into a patient's mouth.

8. A dental treatment tray device according to claim 1, in which the gauze is formed of a knitted material.
